(19) United States
(12) Patent Application Publication
(10) Pub. No.: US 2011/0237145 A1
(43) Pub. Date: Sep. 29, 2011

(54) FOAMS AND MOLDINGS OF SUPPORT MATERIALS COMPRISING FOAMABLE REACTIVE RESINS

(75) Inventors: TOBIAS HEINZ STEINKE, Speyer (DE); Horst Baumgartl, Ludwigshafen (DE); Klaus Hahn, Kirchheim (DE); Jens-Uwe Schierholz, Bensheim (DE); Bettina Wester, Maxdorf (DE); Christof Möck, Mannheim (DE); Bernhard Vath, Mannheim (DE); Peter Nessel, Ludwigshafen (DE); Werner Lenz, Ludwigshafen (DE); Denis Alfred Gonzales, Brussels (BE); Geert De Leersnyder, Wielsbeke (BE)

(73) Assignee: BASF SE, Ludwigshafen (DE)

(21) Appl. No.: 13/072,064

(22) Filed: Mar. 25, 2011

Related U.S. Application Data
(60) Provisional application No. 61/317,303, filed on Mar. 25, 2010.

(51) Int. Cl. B32B 5/20; C08G 12/32; C08J 9/00; B32B 27/12; B05D 5/00; B29C 67/20

(52) U.S. Cl. 442/152; 521/188; 428/319.3; 428/318.4; 442/59; 427/243; 264/46.4; 264/42

(57) ABSTRACT

Foams and moldings comprising foamed support materials selected from the group consisting of polyurethane resins, polyester resins, epoxides and also fiber nonwovens, woven materials and open-cell, two- and three-dimensional networks composed of mineral, animal, vegetable and chemical (natural/synthetic) fibers or mixtures thereof comprising melamine/formaldehyde resins as foamable reactive resin.

The present invention relates to foams and moldings of support materials comprising foamable melamine/formaldehyde resins.

WO-A-2009/77616 discloses moldings wherein the support materials are composed, for example, of open-cell foams, such as open-cell melamine resin foams, PIR (polyisocyanurate), polyimide foams or foams based on inorganic materials. Known in particular therefrom are moldings wherein the support material is a melamine resin foam and the foamable reactive resin is a polyurethane resin, a polyester resin or an epoxy resin.

Moldings of this kind, though, still leave something to be desired.

It was an object of the present invention, therefore, to remedy the disadvantages stated above.

Found accordingly have been new foams and moldings of foamed support materials selected from the group consisting of polyurethane resins, polyester resins, epoxides and mixtures thereof, comprising melamine/formaldehyde resins as foamable reactive resin.

The weight ratio of support material to foamable reactive resin is generally 1% to 50%, preferably 5% to 30%, and more particularly 10% to 20%, by weight.

Suitable support materials for the foams and moldings of the invention are in principle all three-dimensional and sheetlike materials that are known to the skilled worker and can be used as a support, matrix or scaffold. They may in principle take any desired forms or thicknesses. It is preferred to use sheetlike support materials of plate-type arrangement where the third dimension (thickness) is smaller than the first (length) and second (width) dimensions of the sheetlike support material. The length and the width of the sheetlike support material may be the same or different.

The support materials are preferably selected from at least one (foamable) polyurethane resin (PU resin), (foamable) polyester resin or (foamable) epoxy resin. More particularly the support material is a polyurethane resin. Suitable polyurethane resins, polyester resins or epoxy resins are known to the skilled worker. Such resins can be found, for example, in Encyclopedia of Polymer Science and Technology (Wiley) in the following chapters: a) Polyesters, unsaturated: Edition 3, Vol. 11, 2004, pp. 41-64; b) Polyurethanes: Edition 3, Vol. 4, 2003, pp. 26-72 and c) Epoxy resins: Edition 3, Vol. 9, 2004, pp. 678-804. Furthermore, Ullmann's Encyclopedia of Industrial Chemistry (Wiley) contains the following chapters: a) Polyester resins, unsaturated: Edition 6, Vol. 28, 2003, pp. 65-74; b) Polyurethanes: Edition 6, Vol. 28, 2003, pp. 667-722 and c) Epoxy resins: Edition 6, Vol. 12, 2003, pp. 285-303.

Polyurethane resins in the context of the present invention are, in particular, resins based on polyurethane. They are obtained predominantly from air-drying oils (triglycerides, unsaturated fatty acids), which are first transesterified with glycerol to give a mixture of mono- and diglycerides. The resulting products are then reacted with diisocyanates, preferably diisocyanatotoluenes, at an amount-of-substance ratio of isocyanate groups to hydroxyl groups of ≦1:1, to give polyurethanes which no longer contain any isocyanate groups and which, in a manner similar to alkyd resins, dry and cure by air oxidation. They may alternatively be prepared from diisocyanates and polyalcohols (glycerol, pentaerythritol) that are esterified partially with unsaturated acids (e.g., with tall oil).

Polyester resins in the context of the present invention are preferably unsaturated polyester resins. More particularly the polyester resins are reactive resins based on unsaturated polyesters, prepared from unsaturated dicarboxylic acids, such as maleic acid or fumaric acid, and predominantly dihydric alcohols, such as ethylene glycol and propane-1,2-diol, which in the course of the application cure with polymerization and crosslinking to form thermoset materials. They may be prepared using, as additional components, copolymerizable monomers (styrene, α-methylstyrene, vinyltoluene, methyl methacrylate, and others) as solvents or diluents, difunctional monomers (e.g., divinylbenzene, diallyl phthalate) as crosslinkers and curing agents (polymerization initiators, e.g., peroxides), accelerants, pigments, plasticizers, antistats, fillers, and reinforcing agents (organic- or inorganic-based fibers).

Epoxy resins in the context of the present invention are preferably not only oligomeric compounds having more than one epoxide group per molecule, which are used for producing thermosets, but also the corresponding thermosets themselves. Conversion of the epoxy resins into thermosets takes place via polyaddition reactions with suitable curing agents or by polymerization via the epoxide groups. Epoxy resins are produced preferably by reaction of bisphenol A (aromatic dihydroxy compounds) with epichlorohydrin in an alkaline medium to form chainlike compounds.

The polymeric foams are preferably open-cell. For this purpose the conventional, closed-cell foams are aftertreated/reticulated.

Reticulation is a process by which the cell membranes of a foam material are removed almost completely, giving the foam an almost perfect open-cell character.

Reticulation is carried out in a steel chamber, in which either entire foam blocks or, in special roll reactors, rolls with a diameter of approximately 1 m are enclosed. The air is then pumped out and replaced by a combustion gas mixture. Through the ignition of the gas mixture, the resultant heat and pressure wave causes the thinnest structures within the foam, in other words the cell membranes, to be torn apart and to melt onto the cell walls, causing the latter to become thicker. As a result of reticulation, the compressive strength of the foam block reduces by around 20%, but there are increases in the tensile strength and elongation values.

Reticulation produces a high internal block temperature, similar to that after foaming. After reticulation as well, therefore, a cooling time is needed. Reticulated foams have a virtually 100% open-cell character and therefore present minimal flow resistance to gases or liquids. The most frequent application is as filters of all kinds. With the aid of the process of reticulation, the selected foam, in the case of the present invention, is enhanced by expansion of its pores to a size of 20-40 ppi—pores per inch.

Alternatively or additionally to the process of reticulation, it is possible to reduce the density of the foam by machining holes or recesses into the foam in addition to the pores that are present in the foam in any case.

Further suitable support materials include mineral fibers (e.g. glass, mineral wool, basalt), animal fibers (e.g., silk, wool), plant fibers (e.g., cotton), chemical fibers made from natural polymers (e.g., cellulose) and chemical fibers made from synthetic polymers (such as polyamide (PA 6.6—brand name Nylon, PA 6.0—brand name Perlon), polyester (PET (polyethylene terephthalate), PBT (polybutylene terephthalate), PVC (polyvinyl chloride), PP (polypropylene), PE (polyethylene), PPS (polyphenylene sulfide), PAN (polyacrylonitrile), PI (polyimide), PTFE (polytetrafluoroethylene, Teflon), aramids (meta-aramid, brand name, e.g., Nomex, para-aramid, brand name, e.g., Kevlar), polyamideimide (Kermel) (Ullmann's Encyclopedia of Industrial Chemistry, Chapter 13, Fibers, 2003, pages 323 to 652).

Preference is given to nonwovens and wovens and also to two- and three-dimensional, open-cell networks consisting of the fibers specified above.

As support materials it is also possible to use fiber mixtures of the fibers specified above. Use may also be made of multilayer scrims of fibers which are of the same type of material but differ in density and/or basis weights. It is also possible to use multilayer scrims of different kinds of fibers with the same density or different density and with the same or different thickness.

Foams produced from support materials comprising foamable reactive resins are also referred to as hybrid foams. If desired, two or more different foamable reactive resins may also be incorporated into the support material.

Suitability as foamable reactive resin is possessed by melamine/formaldehyde resins, more preferably melamine/formaldehyde resins, leading to an open-cell foam having a density of 25 g/l, in other words 1.6 to 25 g/l, preferably 2 to 15 g/l, more preferably 3 to 23 g/l, more particularly 4 to 12 g/l, and/or a pore size of between 10 and 1000 μm, preferably 50 and 300 μm.

Production processes for melamine/formaldehyde resins and their foams are known, for example, from WO-A-01/94436.

The foams and moldings of the invention may be produced as follows:
1. preparing a solution or dispersion comprising a precondensate of the foam to be produced and optionally further added components (Z),
2. introducing the foamable melamine/formaldehyde resin into a support material,
3. foaming the precondensate in the support material by heating the solution or dispersion from step (2) to a temperature above the boiling temperature of the blowing agent, to obtain a foam, and also, optionally, preferably
4. drying the foam obtained in step (3).

The individual process steps and the various possibilities for variation are detailed below.

The melamine-formaldehyde precondensates generally have a molar ratio of formaldehyde to melamine of 5:1 to 1.3:1 and preferably 3.5:1 to 1.5:1.

These melamine/formaldehyde condensation products, in addition to melamine, may comprise up to 50% by weight, preferably up to 20% by weight, of other thermoset-resin formers and, in addition to formaldehyde, up to 50% by weight, preferably up to 20% by weight, of other aldehydes in cocondensed form. Preference is given to an unmodified melamine/formaldehyde condensation product, however.

Useful thermoset-resin formers include for example alkyl- and aryl-substituted melamine, urea, urethanes, carboxamides, dicyandiamide, guanidine, sulfurylamide, sulfonamides, aliphatic amines, glycols, and phenol and its derivatives.

Useful aldehydes include for example acetaldehyde, trimethylolacetaldehyde, acrolein, benzaldehyde, furfural, glyoxal, glutaraldehyde, phthalaldehyde and terephthal-aldehyde. Further details concerning melamine/formaldehyde condensation products are found in Houben-Weyl, Methoden der organischen Chemie, volume 14/2, 1963, pages 319 to 402.

In a further preferred embodiment, the melamine/formaldehyde precondensate is present in the mixture in an amount from 55% to 85% by weight and preferably from 63% to 80% by weight.

Alcohols, for example methanol, ethanol or butanol, can be added in the course of the preparation of the melamine/formaldehyde precondensate in order to obtain partially or completely etherified condensates. The formation of ether groups can be used to influence the solubility of the melamine/formaldehyde precondensate and the mechanical properties of the completely cured material.

Anionic, cationic and nonionic surfactants and also mixtures thereof can be used as dispersant/emulsifier.

Useful anionic surfactants include for example diphenylene oxide sulfonates, alkane- and alkylbenzenesulfonates, alkylnaphthalenesulfonates, olefinsulfonates, alkyl ether sulfonates, fatty alcohol sulfates, ether sulfates, a-sulfo fatty acid esters, acylaminoalkanesulfonates, acylisothionates, alkyl ether carboxylates, N-acylsarcosinates, and alkyl and alkyl ether phosphates. Useful nonionic surfactants include alkylphenol polyglycol ethers, fatty alcohol polyglycol ethers, fatty acid polyglycol ethers, fatty acid alkanolamides, ethylene oxide-propylene oxide block copolymers, amine oxides, glycerol fatty acid esters, sorbitan esters and alkylpolyglycosides. Useful cationic emulsifiers include for example alkyltriammonium salts, alkylbenzyldimethylammonium salts and alkylpyridinium salts.

The dispersants/emulsifiers can be added in amounts from 0.2% to 5% by weight, based on the melamine/formaldehyde precondensate.

The dispersants/emulsifiers and/or protective colloids can in principle be added to the crude dispersion at any time, but they can also already be present in the solvent at the time the microcapsule dispersion is introduced.

As curatives it is possible to use acidic (acid) compounds which catalyze the further condensation of the melamine resin. The amount of these curatives is generally 0.01% to 20% by weight, preferably 0.05% and 5% by weight, each based on the precondensate. Useful acidic compounds include organic and inorganic acids, for example selected from the group consisting of hydrochloric acid, sulfuric acid, phosphoric acid, nitric acid, formic acid, acetic acid, oxalic acid, toluenesulfonic acids, amidosulfonic acids, acid anhydrides and mixtures thereof.

Depending on the choice of melamine/formaldehyde precondensate, the mixture comprises a blowing agent. The amount of blowing agent in the mixture generally depends on the desired density for the foam.

In principle, the process of the present invention can use both physical and chemical blowing agents (Encyclopedia of Polymer Science and Technology, Vol. I, 3rd Ed., Additives, pages 203 to 218, 2003).

“Physical” or “chemical” blowing agents are suitable. “Physical” blowing agents herein are volatile liquids or compressed gases which acquire their blowing agent property through physical treatment (e.g., temperature, pressure). “Chemical” blowing agents herein are blowing agents which acquire their blowing agent property through chemical reaction or chemical decomposition with the release of gas.

Useful “physical” blowing agents include for example hydrocarbons, such as pentane, hexane, halogenated, more particularly chlorinated and/or fluorinated, hydrocarbons, for example methylene chloride, chloroform, trichloroethane, hydrochlorofluorocarbons, partially halogenated hydrochlorofluorocarbons (H—CFCs), alcohols, for example methanol, ethanol, n-propanol, isopropanol, ethers, ketones and esters, for example methyl formate, ethyl formate, methyl acetate or ethyl acetate, in liquid form or air, nitrogen or carbon dioxide as gases.

Useful “chemical” blowing agents include for example isocyanates mixed with water, releasing carbon dioxide as active blowing agent. It is further possible to use carbonates and bicarbonates mixed with acids, in which case carbon dioxide is again produced. Also suitable are azo compounds, for example azodicarbonamide.

In a preferred embodiment of the invention, the mixture further comprises at least one blowing agent. This blowing agent is present in the mixture in an amount of 0.5% to 60% by weight, preferably 1% to 40% by weight and more preferably 1.5% to 30% by weight, based on the melamine/formaldehyde precondensate. It is preferable to add a physical blowing agent having a boiling point between 0 and 80° C.

In a further embodiment, in addition to the melamine-formaldehyde precondensate of the foam to be produced and the nanoparticles, the mixture also comprises an emulsifier and also optionally a curative and optionally a blowing agent.

In a further embodiment, the mixture is free of further added substances. However, for some purposes it can be advantageous to add from 0.1% to 20% by weight, preferably from 0.1% to 10% by weight, based on the melamine/formaldehyde precondensate, of customary added substances, such as dyes, flame retardants, UV stabilizers, agents for reducing the toxicity of fire gases or for promoting carbonization.

It is also possible to add added substances to the melamine/formaldehyde precondensate. In one embodiment, the abrasive foams comprise at least one added substance from the group consisting of dyes, fragrances, optical brighteners, UV absorbers and pigments. This added substance is preferably in homogeneous distribution in the foam.

Useful pigments include the common inorganic natural pigments (chalk for example) or synthetic pigments (titanium oxides for example), but also organic pigments.

The foamable reactive resin can be introduced (step 2) into the support material by any of the methods known to the skilled worker, as for example by impregnating the support material with foamable reactive resin. Alternatively (the surface of) the support material may also be sprayed with foamable reactive resin and, if desired, subsequently rolled or rollered into the support material (WO-A-2009/077616). Normally the foamable reactive resin is applied very uniformly. The process of the invention can be carried out such that the support material is immersed completely into the impregnating solution comprising the foamable reactive resin, or else only one flat side of the support material is immersed.

In one preferred embodiment a combination of open-cell foam and a melamine/formaldehyde resin foam can be produced, preferably batchwise.

For this purpose, in a foaming apparatus with variable pressure settings, the solution or dispersion comprising a precondensate from step (1) may be combined with the support material. There are different combinations possible:
1. The support material is introduced and the foamable reactive resin is applied very uniformly
2. The support material is impregnated with the foamable reactive resin and then placed in the foam mold
3. The melamine/formaldehyde resin is introduced first and the support material is then added.

In another preferred embodiment a combination of support material and a melamine/formaldehyde resin foam may be produced preferably in a continuous process.

There are different ways of combining support material and melamine/formaldehyde resin. The support material may be supplied to the foaming apparatus via a continuous roll. The support material may be compressed beforehand, and so on foaming with the melamine/formaldehyde resin the support material attains the full foam height (i.e., original thickness of the support material). Moreover, the support material may be expanded on foaming, so that it tears along the foam direction and hence loses the original composite structure.
1. The support material may be supplied via the bottom of the foaming apparatus. The support material, for example, may be attached to the underside of the foaming apparatus, using a touch-and-close tape. The slurry may be applied to the support material from above.
2. The support material may be guided into the foaming apparatus above the melamine/formaldehyde resin, and so the melamine/formaldehyde resin is able to penetrate the support material during the foaming operation (and to expand).
3. The melamine/formaldehyde resin may be injected directly into the support material and rolled in. Rolling may remove, for example, excess foamable reactive resin, until the desired amount of foamable reactive resin is present in the support material.

In process step (3), heating takes place for the purpose of foaming the precondensate and, where present, the support material. By heating the solution or dispersion from step (2) to a temperature above the boiling point of the blowing agent used, a foam can be obtained. The precise temperature for application is dependent inter alia on the blowing agent used (e.g., on its boiling point). The heating in step (3) may take place, for example, through the use of hot gases (such as air or inert gas) and/or through high-frequency irradiation (microwaves, for example).

Energy may be introduced preferably by electromagnetic radiation, as for example by high-frequency irradiation at 5 to 400 kW, preferably 5 to 200 kW, more preferably 9 to 120 kW, per kilogram of mixture used, in a frequency range from 0.2 to 100 GHz, preferably 0.5 to 10 GHz. A suitable radiation source for dielectric radiation is magnetrons, in which case irradiation may take place with one or more magnetrons at the same time.

To conclude, the foams produced are dried, removing blowing agent and water that have remained in the foam.

The properties of the hybrid foam produced in this operation are a product of the foamable melamine-formaldehyde resin employed and of the set density of the support material.

The melamine resin foams produced in accordance with the invention generally have a density of 5 to 100 g/l, more preferably 10 to 50 g/l.

The hybrid foam may further comprise additives as well. Examples of suitable additives include flame retardants such as intumescent materials, alkali metal silicates, melamine, melamine polyphosphate, melamine cyanurate, aluminum hydroxide, magnesium hydroxide, ammonium polyphosphates, organic phosphates or else flame retardant halogen compounds. Likewise suitable as additives are plasticizers, nucleators, IR absorbers such as carbon black and graphite, aluminum oxide powders or Al(OH)₃, soluble and insoluble colorants, biocidal substances (such as fungicides), and pigments.

If desired, the hybrid foam may also be reinforced with further organic or inorganic particles. Such particles are introduced preferably as a blend with the foamable reactive resin. Examples of suitable reinforcing fillers include the following: short glass fibers, talc, chalk or other minerals, nanotubes, phyllosilicates or carbon fibers. These additions may be made to the support material itself.

The melamine resin foams of the invention find application in the cushioning of seat areas, as heat, cold and/or sound protection or insulation/encapsulation of buildings and parts of buildings, more particularly walls, partitions, roofs, facades, doors, ceilings and floors, of vehicles of any kind on land, on water, in the air and in space, whether for transporting cargo or people, or any such combination in passenger cars, trucks, for example for encapsulating the engine compartment (such as engine hoods) or passenger cells, in rail traffic in the rail cars in goods or passenger traffic, and also in locomotives, in aircraft, for example in the cabin interior, the cockpit or the cargo hold, and also in space travel, in manned or unmanned flying objects such as spaceships and space gliders, space capsules or satellites, for low-temperature insulation, for example, of cooling assemblies, refrigerators, cold stores, tank systems and containers for any desired liquids, more particularly for oil and gas or liquid gas down to (−278° C.), for storage and in transportation, for absorption and completely or partially reversible release of liquids down to (−273° C.) as “sponge”, in the cleaning industry for the cleaning of surfaces, for example, in the form of sponges or saturated with cleaning agents of any kind, inter alia for washing operations in (fully) automatic washing machines, as shock-dampening or shock-insulating packaging material, in hygiene applications (diapers, sanitary napkins) and also in the textile sector (apparel).

Examples of the use of melamine/formaldehyde resin foams in hygiene applications are found for example in WO-A-02/26872 and WO-A-02/26871.

In one specific embodiment of the process of the invention, the support material comprising foamable reactive resin (hybrid foam) may be subjected to compressive deformation. Heat-induced deformations of melamine resin foams are already known from EP-A-111 860.

Processes for producing three-dimensional shaped articles from open-cell, elastic, thermoset foams, where the foam either a) is boiled with water or treated with steam at a temperature of 100 to 180° C. for a time of 0.1 to 120 min and then deformed at a temperature of 20 to 280° C. under a pressure of 0.1 to 100 bar, or b) is deformed under a pressure of 1.5 to 15 bar and then treated with steam at a temperature of 100 to 180° C. for a time of 0.1 to 60 min in the deformed state.

The term “compressive deformation” or “compressive deformation step” refers in the context of the present invention to the treatment of the support material comprising the foamable reactive resin (hybrid foam) at elevated pressure and elevated temperature. A suitable mold is used that is known to the skilled worker and is preferably heatable, its shape determining the shaping of the molding to be produced. It is possible here, for example, to use what are called inserts or molds having specially shaped surfaces to produce workpieces (moldings) with a wide variety of different appearances and/or thicknesses.

By elevated pressure is meant any pressure greater than atmospheric pressure (1 bar). In accordance with the invention, this step is normally carried out by inserting the support material obtained, comprising the foamable reactive resin, into a suitable mold, and then applying pressure. In one preferred embodiment of the present invention the compressive deformation step is carried out at elevated temperature. In this preferred embodiment, this is also referred to as a thermoforming step. The principle here is that the higher the temperature used in the step, the lower the residence time in the mold of the support material comprising the foamable reactive resin.

The compressive deformation is carried out preferably at a temperature of 50 to 200° C. and/or a pressure of 2 to 200 bar. Depending on the system used, the completed molding may be removed after several minutes, as for example after 0.5 to 2 minutes. If desired, the compressive deformation step may also be carried out over a longer period of time.

The moldings are generally moldings of any size, extent, and shape that can be produced with molds, such as stars, spheres, cubes, cuboids, rings, cylinders, hollow cylinders, half-shells, extrudates, intended for example for casings, cushions, rotors, aerofoils and fuselages for aircraft and space vehicles, for passenger cells and their interior trim in automobiles, trucks, buses and any kind of utility vehicles, and preferably are sheetlike moldings, in other words those moldings where the third dimension (thickness) is smaller than the first (length) and second (width) dimensions.

The present invention further provides panels comprising such moldings, and also the use of these moldings and the panels in vehicle construction, including aircraft construction, railroad construction or as a fire protection layer, more particularly as lightweight components.

The physical properties of the moldings obtained are dependent on the degree of compression, on the support material used, on the foamable reactive resin used, and on the fraction of the reactive resin in the support material. Parts with a virtually unlimited spectrum of properties can be produced.

The moldings may be produced in a manner which can be automated, and generally possess better mechanical properties. Hence the foams and moldings of the invention are notable for high compressive strength and tear propagation resistance, and also for high and stable deformability. Moreover, they have a low density and a light weight, and low flammability, and so can also be used as a fire protection layer. The reason for the particular advantage of the moldings of the invention is that, by virtue of the process of the invention, they are easily able to take on any desired form and at the same time this form is very stable.

As a result of the compressive deformation step the thickness of the completed (e.g., flat) molding is normally less than or at most equal to the thickness of the support material used. The molding after compressive deformation has a thickness preferably of 80% in comparison to the thickness of the support material used. In one embodiment of the present invention the thickness of the completed molding may be reduced to 10% to 50% of the thickness of the support material used.

Before or following compressive deformation, preferably before it, it is possible in one embodiment of the present invention to apply an outer layer to at least one (flat) side of the support material comprising foamable reactive resin. When the outer layer is applied prior to compressive deformation, it is applied to one or more (flat) sides (surfaces) of the support material comprising the foamable reactive resin (hybrid foam). Where the outer layer is applied after compressive deformation, it is applied to one side (surface) of the completed molding. It is preferred to apply an outer layer to each of the two opposite (flat) sides of the support material comprising the foamable reactive resin. In that case the materials in question may be either identical materials or different materials. If desired it is possible to apply two or more outer layers to at least one side or to two opposite sides of the hybrid foam or completed molding. A molding of the invention which has an outer layer on at least one side (surface) of the support material comprising the foamable reactive resin is referred to as a panel. Where there is an outer layer on each of two opposite sides of the support material comprising the foamable reactive resin, the term sandwich panel is used.

Suitability as outer layer is possessed in principle by all of the outer layers that are known to the skilled worker. Preferably the outer layer is composed wholly or at least partly of metal, more particularly aluminum, wood, insulating material, plastics, in the form for example of polymeric films or plastics sheets, corrugated metal sheet, other metal sheets, glass fiber wovens, glass fiber mats, plaster or chipboard. Where an outer layer of wood is used, it is preferably of wood veneer; outer layers of plastic also include polyurethane foams. With greater preference the outer layer is of aluminum, metal sheets, glass fiber wovens, polymeric films, plastics sheets or wood veneer, with particular preference of aluminum. The outer layer is preferably a foil/film, a glass fiber mat or both.

The outer layer is preferably applied to the support material comprising the foamable reactive resin after the material has been rolled out. The thickness of the outer layer is preferably less than the thickness of the support material, preferably less by a factor of at least 10. Suitable outer layers are, for example, an aluminum foil 0.1 mm thick. Preferably, in the subsequent step of compressive deformation, the molding comprising at least one outer layer is compressed to ≦80% of the initial thickness of the support material. The adhesion between hybrid foam and outer layer normally results from the foamable reactive resin that exudes from the foam in the course of compression.

The present invention further provides a panel comprising at least one molding of the invention producible by a process in accordance with the above description. For the purposes of the present invention the term “panel” refers more particularly to those articles which have a molding (core) and, applied atop said molding, on at least one (flat) side, an outer layer. Panels may be straight (unbowed) or may have one (or, if desired, two or more points of) curvature (bowed). Furthermore, panels may also be textured. The panel is preferably a sandwich panel, in which an outer layer has been applied to each of the opposite (flat) sides of the molding. Suitable outer layers have already been set out above. If desired, the two outer layers may be of different materials, but are preferably of the same materials. More particularly the two outer layers are selected from aluminum, metal sheets, glass fiber wovens, glass fiber mats, polymeric films, plastics sheets or wood veneer.

The present invention further provides a process for producing such panels comprising at least one molding of the invention. The process for producing the panels corresponds in principle to the above-described process for producing the moldings of the invention.

In the course of the deformation and curing of the moldings, not only is a frictional connection produced between outer layers and foam core, but the outer layers can also be deformed in unison with the foam core.

The present invention further provides for the use of the (flat) moldings of the invention in vehicle construction or else as a fire protection layer. The moldings of the invention are preferably used in vehicle construction, more particularly for automobiles, trucks and buses and for agricultural, forestry and construction machinery, for aircraft such as airplanes and airships, in the construction of aircraft and space vehicles or of rail vehicles such as railroads. The particular advantage associated with the use of the moldings of the invention in vehicle construction has its foundations in the possibility of deforming said moldings into any desired shapes in a simple way on the basis of the production process, in particular through the thermoforming step. These shapes, in turn, are highly stable, possess outstanding mechanical properties, and are also of low flammability. The present invention further provides for the use of a panel comprising a molding of the invention in vehicle construction, more particularly for aircraft or railroads, or as a fire protection layer.

Moreover, the foams and moldings of the invention may be used as sound-absorbing panels in construction. Furthermore, the foams of the invention are suitable for energy absorption in the packaging sector.

### EXAMPLES

### Example 1

Production of a foam modified with a polyester (PET) fiber nonwoven 75 parts by weight of a spray-dried melamine/formaldehyde precondensate (molar ratio 1:3) were dissolved in 25 parts by weight of water. This resin solution was admixed with 3% by weight of formic acid, 2% by weight of an Na C12/C14 alkyl sulfate, and 20% by weight of pentane, based in each case on the resin. A polyester fiber nonwoven (density 800 g/m², 25% by weight based on the resin) was impregnated with the aqueous melamine/formaldehyde mixture, then foamed in a polypropylene (foaming) mold by injection of microwave energy. The foaming was followed by drying for 30 minutes.

The results are summarized in table 1.

### Example 2

### Production of a Foam Modified with a Reticulated PU Foam

75 parts by weight of a spray-dried melamine/formaldehyde precondensate (molar ratio 1:3) were dissolved in 25 parts by weight of water. This resin solution was admixed with 3% by weight of formic acid, 2% by weight of an Na C12/C14 alkyl sulfate, and 20% by weight of pentane, based in each case on the resin.

The aqueous melamine/formaldehyde resin mixture was introduced into a polypropylene (foaming) mold, and then an open-cell PU foam (density 30 g/l) was placed onto the slurry. Foaming was carried out by injection of microwave energy. Foaming was followed by drying for 30 minutes.

The results are summarized in table 1.

### Comparative Example A

75 parts by weight of a spray-dried melamine/formaldehyde precondensate (molar ratio 1:3) were dissolved in 25 parts by weight of water. This resin solution was admixed with 3% by weight of formic acid, 2% by weight of an Na C12/C14 alkyl sulfate, and 20% by weight of pentane, based in each case on the resin. The mixture was then stirred and foamed in a polypropylene (foaming) mold by injection of microwave energy. Foaming was followed by drying for 30 minutes.

The results are summarized in table 1.

TABLE 1

| | | Ram | Tear propagation resistance |
|---|---|---|---|
| | Density | pressures | DIN ISO 34-1:04-07 |
| | [g/l] | [N/kN] | method B [N] |
| Example 1 | 13 | 66.7 | 3.48 |
| Example 2 | 39 | 47.2 | 9.02 |
| Comparative | 8 | 34.7 | 2.07 |
| example A | | | |

### Ram Pressure Measurement

The mechanical quality of the melamine resin foams was assessed through a ram pressure measurement conducted in accordance with U.S. Pat. No. 4,666,948. For this measurement, a cylindrical ram having a diameter of 8 mm and a height of 10 cm was pressed at an angle of 90° into a cylindrical sample having a diameter of 11 cm and a height of 5 cm, in foaming direction, until the sample underwent tearing. The tearing force [N/kN] provides information on the quality of the foam.

1-7. (canceled)

8. Foams and moldings of support materials comprising melamine/formaldehyde resins as foamable reactive resins.

9. The foams and moldings according to claim 8, wherein polyurethane resins, polyester resins, epoxides or mixtures thereof are used as support materials.

10. The foams and moldings according to claim 8, wherein mineral, animal, vegetable and chemical, natural or synthetic fibers, and also nonwovens and woven materials comprising these fibers, are used as support materials.

11. A process for producing foams and moldings according to claim 8, wherein the foamable reactive resin is introduced into the support material and is foamed at temperatures above the boiling temperature of the blowing agent, and heat treatment is carried out optionally.

12. A method for producing foams and moldings for cushioning and for heat, cold and sound protection comprising: utilizing the foams and moldings according to claim 8.

13. A method for producing foams and moldings for vehicle construction for automobiles, trucks, buses, agricultural and construction machinery, rail vehicles, and in the construction of aircraft and space vehicles comprising: utilizing the foams and moldings according to claim 8.

14. A method for producing panels in vehicle construction for automobiles, trucks, buses, agricultural and construction machinery, rail vehicles, and in the construction of aircraft and space vehicles comprising: utilizing the foams and moldings according to claim 8.
